(19) United States
(12) Patent Application Publication
(10) Pub. No.: US 2019/0041826 A1
(43) Pub. Date: Feb. 7, 2019

(54) TOOL MANAGEMENT SYSTEM, TOOL MANAGEMENT METHOD, AND COMPUTER-READABLE STORAGE MEDIUM STORING COMPUTER PROGRAM FOR ALLOWING COMPUTER TO ACT AS TOOL MANAGEMENT SYSTEM

(71) Applicant: Roland DG Corporation, Hamamatsu-shi (JP)

(72) Inventors: Kazutoshi MATSUO, Hamamatsu-shi (JP); Tetsuya KANJA, Hamamatsu-shi (JP); Ryo ISHIGAKI, Hamamatsu-shi (JP)

(21) Appl. No.: 16/157,170

(22) Filed: Oct. 11, 2018

Related U.S. Application Data
(62) Division of application No. 14/294,249, filed on Jun. 3, 2014.

(30) Foreign Application Priority Data
Jun. 4, 2013 (JP) 2013-117711

(51) Int. Cl. G05B 19/4065

(52) U.S. Cl. CPC G05B 19/4065; G05B 2219/37252

(57) ABSTRACT

A tool management system configured to managing a life of a tool in a processing device includes an acquisition unit configured to, when it is detected that a target tools is in use, acquire a stocker number of a position at which the target tool in use is accommodated from a processing program, a determination unit configured to acquire a time for replacement of the target tool corresponding to the stocker number and determine whether or not the total use time of the target tool has reached the time for replacement; and an output unit configured to, when the determination unit determines that the total use time has reached the time for replacement, output an instruction to provide a display urging replacement of the target tool.

### BACKGROUND OF THE INVENTION

### 1. Field of the Invention

The present invention relates to a tool management system and a tool management method for managing the life of a tool of a processing device, and a non-transitory computer-readable storage medium that stores a computer program that allows a computer to act as a tool management system.

The present application claims priority from Japanese Patent Application No. 2013-117711 filed on Jun. 4, 2013, which is incorporated by reference herein in its entirety.

### 2. Description of the Related Art

Conventionally, a processing device that performs a cutting process on a work based on predetermined processing data by use of numerical control provided by a microcomputer or the like is known. Such a processing device includes a carriage to which a tool is attached and a holding device that holds the work, and cuts the work into a desired shape by use of the tool.

When the tool reaches the end of the life, the processing device may not perform a proper processing operation or the tool may be destroyed and damage the processing device. Therefore, operators, for example, write down the number of times or the length of time that the tool has been used so as to be aware of when the tool reaches the end of the life. The “life” of the tool refers to the maximum length of time in which the tool can be used properly.

However, since the operators, for example, write down the total use time after using the processing device, there may be human errors such that, for example, the operators forget to write down the total use time, or make an error in measuring, in writing down, or in calculating the total use time. For this reason, there is a problem that correct management cannot be performed to determine whether or not the tool has reached the end of the life.

### SUMMARY OF THE INVENTION

Preferred embodiments of the present invention provide a tool management system and a tool management method for detecting that a tool has reached the end of the life and also urging an operator to replace the tool, and a non-transitory computer-readable storage medium storing a computer program that allows a computer to act as such a tool management system.

A tool management system according to a preferred embodiment of the present invention is configured to manage a life of a tool in a processing device that includes a stocker, in which a plurality of positions at which tools are accommodated are each assigned a stocker number, and performs a processing operation by a processing program using the stocker number. The tool management system includes a first setting unit configured to set name information, a total use time and a time for replacement for each of a plurality of tools based on an input by an operator; a second setting unit configured to set, from the name information of the plurality of tools set by the first setting unit, name information of each of tools accommodated at the positions assigned stocker numbers in the stocker as name information of each of target tools, the life of which is to be managed, based on an input by the operator; a storage unit configured to store the name information, the total use time and the time for replacement of each of the plurality of tools set by the first setting unit and the name information of each of the target tools set by the second setting unit; a detection unit configured to detect whether or not one of the target tools is in use at an interval of a predetermined time in the processing operation; an acquisition unit configured to, when the detection unit detects that one of the target tools is in use, acquire the stocker number of the position at which the target tool in use is accommodated from the processing program; an update unit configured to acquire the total use time of the target tool corresponding to the stocker number acquired by the acquisition unit and add the predetermined time to the acquired total use time to update the total use time; a determination unit configured to acquire the time for replacement of the target tool corresponding to the stocker number acquired by the acquisition unit and determine whether or not the total use time updated by the update unit has reached the time for replacement; and an output unit configured to, when the determination unit determines that the total use time updated by the update unit has reached the time for replacement, output an instruction to provide a display urging replacement of the target tool.

A tool management system according to another preferred embodiment of the present invention is configured to manage a life of a tool in a processing device that performs a processing operation by a processing program using name information of the tool. The tool management system includes a setting unit configured to set name information, a total use time and a time for replacement for each of a plurality of tools based on an input by an operator; a storage unit configured to store the name information, the total use time and the time for replacement of each of the plurality of tools set by the setting unit; a creation unit configured to create the processing program such that the name information of the plurality of tools is included, and output the processing program to the processing device; a detection unit configured to detect whether or not one of the plurality of tools is in use at an interval of a predetermined time in the processing operation; an acquisition unit configured to, when the detection unit detects that one of the plurality of tools is in use, acquire the name information of the tool in use from the processing program; an update unit configured to acquire the total use time of the tool corresponding to the name information acquired by the acquisition unit and add a predetermined time to the acquired total use time to update the total use time; a determination unit configured to acquire the time for replacement of the tool corresponding to the name information acquired by the acquisition unit and determines whether or not the total use time updated by the update unit has reached the time for replacement; and an output unit configured to, when the determination unit determines that the total use time updated by the update unit has reached the time for replacement, output an instruction to provide a display urging replacement of the tool.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram showing an example of hardware structure of a tool management system.

FIG. 2 is a block diagram showing an example of functional structure of the tool management system.

FIG. 3 is a flowchart showing an example of tool life management process.

FIG. 4 is a flowchart showing a setting process in the tool life management process.

FIG. 5 is a flowchart showing a tool replacement instruction output process in the tool life management process.

FIG. 6a shows an example of balloon message urging tool replacement, FIG. 6b shows an example of dialog display urging tool replacement, and FIG. 6c shows an example of e-mail message urging tool replacement.

FIG. 7 shows an example of tool information setting window.

FIG. 8 shows an example of target tool setting window.

FIG. 9 is a block diagram showing another example of functional structure of the tool management system.

FIG. 10 is a flowchart showing another example of tool life management process.

FIG. 11 is a flowchart showing a setting process in the tool life management process.

FIG. 12 is a flowchart showing a tool replacement instruction output process in the tool life management process.

FIG. 13 shows an example of name information setting window.

FIG. 14 is a flowchart showing a modified example of the setting process in the tool life management process.

### DETAILED DESCRIPTION OF THE PREFERRED EMBODIMENTS

Hereinafter, preferred embodiments of a tool management system, a tool management method, a computer program that allows a computer to act as a tool management system (hereinafter, the computer program will be referred to simply as a “program”), and a non-transitory computer-readable storage medium that stores such a program will be described with reference to the attached drawings.

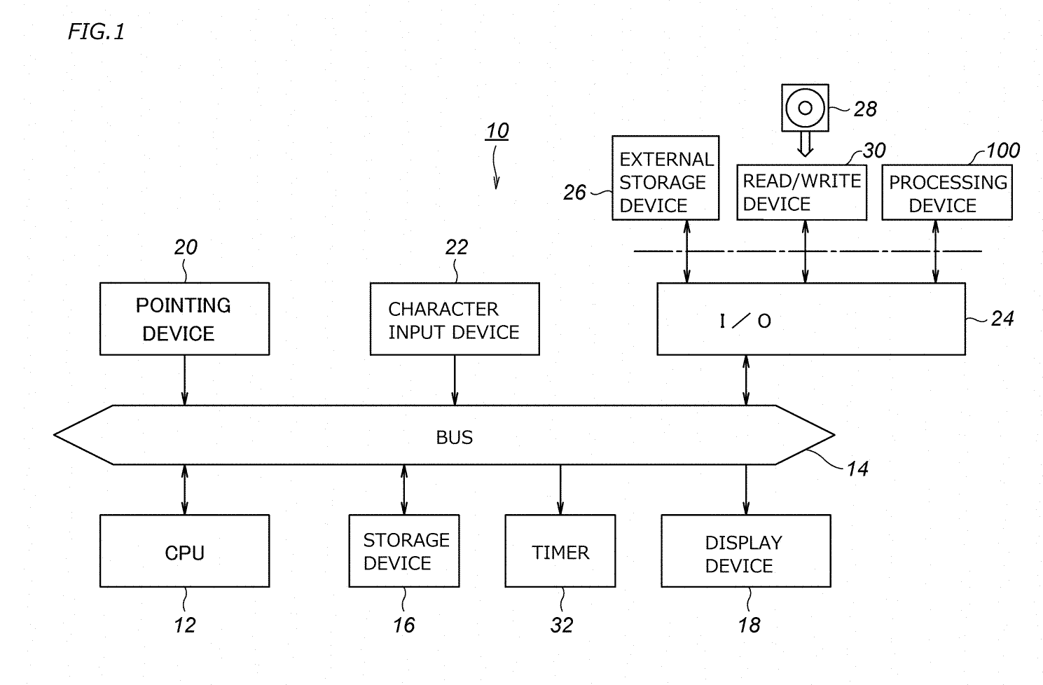

First, with reference to FIG. 1, a first preferred embodiment of the tool management system will be described. A tool management system 10 preferably is realized by, for example, a known personal computer or general-purpose computer. An operation of the tool management system 10 is controlled by a central processing unit (hereinafter, referred to as a “CPU”) 12.

The tool management system 10 includes, the CPU 12, a storage device 16, a display device 18, a pointing device 20, a character input device 22, an input/output interface circuit (hereinafter, referred to as an “I/O”) 24, and a timer 32 that measures time.

The storage device 16 is connected to the CPU 12 via a bus 14. The storage device 16 preferably is, for example, a read only memory (ROM) that stores a program for control on the CPU 12, various types of data or the like, and a random access memory (RAM) including a storage area used as a working area for the CPU 12. The display device 18 includes a CRT or liquid crystal screen that provides various types of displays. The pointing device 20 is an input device that specifies an arbitrary position on a display screen of the display device 18, and is a mouse or other suitable known input device. The character input device 22 is an input device that inputs an arbitrary character, and is a keyboard or other suitable known input device. The I/O 24 is configured transmit and receive a signal to and from various external devices.

The tool management system 10 is connected to an external storage device 26 such as a hard disc drive or the like via the I/O 24. The tool management system 10 is connected to a read/write device 30 via the I/O 24. The read/write device 30 writes and stores various types of data, created based on control performed by the CPU 12, on a non-transitory computer-readable storage medium (hereinafter, optionally referred to as a “storage medium”) 28. The read/write device 30 also reads various types of data stored on the storage medium 28. The storage medium 28 is not limited to any specific type of medium, and is, for example, a compact disc (CD) or a digital versatile disc (DVD). The tool management system 10 is connected to a processing device 100 via the I/O 24. The processing device 100 is configured and programmed to perform a processing operation on a work by use of a processing program created based on processing data. The processing device 100 may be a conventionally known processing device such as a microprocessor, computer, etc., and will not be described in detail herein.

In the following description, a program used to execute a tool life management process and various types of data used for the tool life management process are pre-stored on the storage device 16. Alternatively, the program and the data may be read from an external device onto the random access memory in the storage device 16 by wireless or wired communication.

The processing program is a program that allows the processing device 100 to perform a processing operation. The processing program is created by a personal computer or the like connected to the processing device 100 based on processing data that indicates a shape of the work after the processing operation. In this preferred embodiment, the processing program created by the personal computer preferably is output to the processing device 100 and stored on a storage unit (not shown) in the processing device 100.

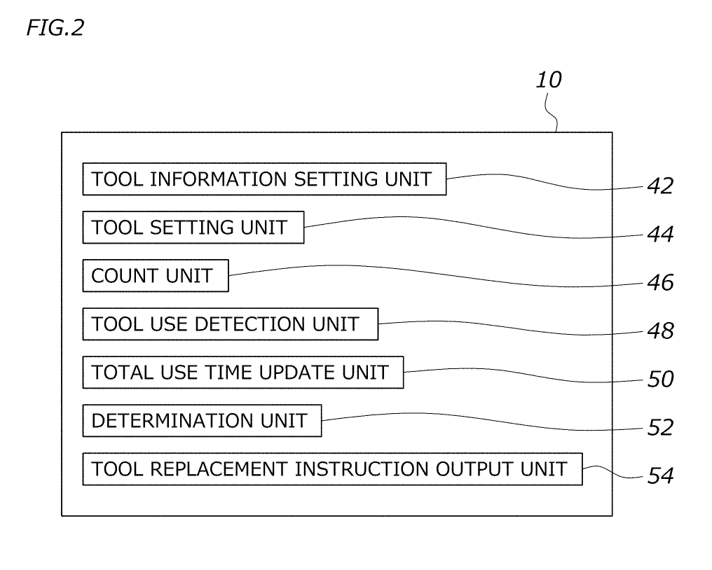

FIG. 2 is a block diagram showing a functional structure of the tool management system 10. The tool management system 10 makes stocker numbers included in the processing program and names of the tools to correspond to each other respectively. The tool management system 10 monitors a total use time of a tool that is set by an operator, and when the total use time reaches a preset time for replacement of the tool, displays a message that urges replacement of the tool. In this specification, the “total use time” refers to a length of time in which the tool has been used for the processing operation. The “time for replacement” refers to a time length representing the life of the tool, namely, a rough estimate of the time length for which the tool can be used.

The tool management system 10 includes a tool information setting unit 42 that sets information on tools (name information, total use time, and time for replacement of each of the tools, etc.), a tool setting unit 44 configured to set a tool, the life of which is to be managed (hereinafter, referred to as a “target tool”), a count unit 46 configured to count the time measured by a timer 32, a tool use detection unit 48 configured to detect, at an interval of a predetermined time, whether or not the target tool is in use, a total use time update unit 50 that, when the tool use detection unit 48 detects that the target tool is in use, update the total use time of the target tool, a determination unit 52 configured to determine whether or not the total use time of the target tool has reached the time for replacement, and a tool replacement instruction output unit 54 configured to output an instruction to provide a display urging replacement of the tool based on the determination of the determination unit 52.

This will be described in more detail. The tool information setting unit 42 is configured to set a total use time and a time for replacement of each of the tools, that have been input by the operator by use of the character input device 22, for the name information of the corresponding tool that has been input by the operator by use of the character input device 22. The name information, the total use time and the time for replacement of each tool that have been set in this manner are output to, and stored on, the storage device 16 as tool information on the corresponding tool. From the tools, the tool information on which has been set by the tool information setting unit 42, the operator selects a tool, the life of which is to be managed, and the tool setting unit 44 sets this tool as a target tool. The selection by the operator is performed by use of the pointing device 20 and/or the character input device 22. The tool that is set as a target tool is output to, and stored on, the storage device 16. The tool setting unit 44 sets the name information of the target tool.

The processing device 100 includes a stocker in which a plurality of positions at which the tools are accommodated are each assigned a stocker number (hereinafter, the number assigned to each of the positions in the stocker at which the tools are accommodated will be referred to as a “stocker number”). The processing program is created so as to use the stocker number. The processing device 100 is actuated by the processing program and performs the processing operation while replacing the tools accommodated in the stocker when necessary.

In the processing program, a tool to be used for the processing operation is specified by the stocker number. The operator sets the target tool as follows. From the tools, the tool information on which has been set by the tool information unit 42, the operator inputs the name information of the target tool in correspondence with the stocker number of the position in the stocker at which the tool is accommodated.

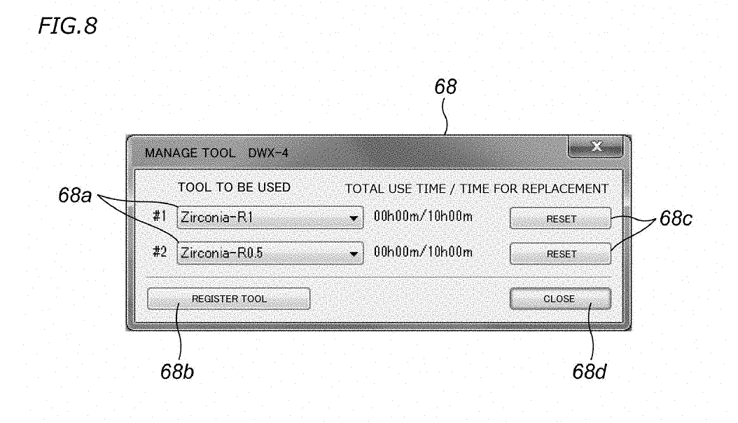

It is assumed that, for example, the processing device 100 includes a stocker capable of accommodating two tools, and the positions at which the two tools are accommodated are assigned stocker numbers “#1” and “#2”. The operator inputs “Zirconia-R1”, which is the name information of the tool accommodated at the stocker position “#1” in the stocker, to the stocker number “#1” on a window used to set a target tool. As a result, the tool name “Zirconia-R1” is set for the stocker number “#1”, and the total use time and the time for replacement of this tool stored on the storage device 16 are displayed on the window (see FIG. 8). The operator inputs “Zirconia-R0.5”, which is the name information of the tool accommodated at the stocker position “#2” in the stocker, to the stocker number “#2” on the window used to set a target tool. As a result, the tool name “Zirconia-R0.5” is set for the stocker number “#2”, and the total use time and the time for replacement of this tool stored on the storage device 16 are displayed on the window (see FIG. 8).

At this point, the total use time and the time for replacement have already been set for the tools “Zirconia-R1” and “Zirconia-R0.5” by the tool information setting unit 42 and stored on the storage device 16.

The count unit 46 is configured to monitor a control unit (not shown) in the processing device 100. The count unit 46 is also configured to, when the processing device 100 starts the processing operation by an instruction from the operator, start counting the time measured by the timer 32. Namely, the count unit 46 determines whether or not the processing operation has been started by the processing device 100, and when the processing operation is started by the processing device 100, starts counting the time from the time at which the processing operation is started. The count unit 46 determines whether or not the count number has reached a predetermined count number. When determining that the count number has reached the predetermined count number, the count unit 46 determines that a predetermined time has elapsed and outputs a signal indicating that the predetermined time has elapsed to the tool use detection unit 48. The predetermined time is, for example, 1 minute, but may be 30 seconds or 2 minutes. The predetermined time may be optionally set in consideration of the time for replacement. The predetermined time may be preset or may be settable by the operator.

When the signal indicating that the predetermined time has elapsed is output from the count unit 46, the tool use detection unit 48 monitors the control unit (not shown) in the processing device 100 and detects whether or not a tool is in use. When detecting that a tool is in use, the tool use detection unit 48 acquires the stocker number of the tool that is in use. When a tool is in use, the stocker number of the tool in use has been read onto the control unit (not shown) in the processing device 100. There is no specific limitation on the method for detecting whether or not a tool is in use. For example, when a spindle is rotated to perform a processing operation on a work in the processing device 100, it is determined that a tool is in use; and otherwise, it is determined that no tool is in use.

When detecting that a tool is in use, the tool use detection unit 48 outputs the stocker number of the tool in use to the total use time update unit 50. When detecting that no tool is in use, the tool use detection unit 48 monitors the control unit (not shown) in the processing device 100 and detects whether or not the processing operation has been finished in the processing device 100. There is no specific limitation on the method for detecting whether or not the processing operation has been finished. For example, when the spindle has stopped rotating and is at a wait position in the processing device 100, it is determined that the processing operation has been finished; and otherwise, it is determined that the processing operation has not been finished.

The total use time update unit 50 adds the predetermined time to the total use time of the target tool that is in use to update the total use time. The total use time update unit 50 first reads, from the storage device 16, the total use time of the target tool corresponding to the stocker number of the target tool that is output from the tool use detection unit 48. At this point, the tool information on the target tool accommodated in the stocker provided in the processing device 100 has been preset by the operator and stored on the storage device 100. The total use time update unit 50 adds the predetermined time to the read total use time of the target tool to update the total use time of the target tool.

The total use time updated in this manner is output to, and stored on, the storage device 16. The total use time updated in this manner is also output to the determination unit 52 together with the stocker number of the target tool in use.

It is assumed that, for example, the tool “Zirconia-R1” is set as a target tool for the stocker number “#1”, and the total use time and the time for replacement of “Zirconia-R1” are “00 hr. 00 min.” and “10 hr. 00 min.”. It is also assumed that the tool “Zirconia-R0.5” is set as a target tool for the stocker number “#2”, and the total use time and the time for replacement of “Zirconia-R0.5” are “00 hr. 15 min.” and “10 hr. 00 min.”.

Now, it is assumed that the stocker number “#1” is output from the tool use detection unit 48 to the total use time update unit 50. In this case, the total use time update unit 50 reads the total use time of “Zirconia-R1” stored on the storage device 16, namely, “00 hr. 00 min.”, and adds the predetermined time to “00 hr. 00 min.” to update the total use time. In the case where, for example, the predetermined time is “1 min.”, the total use time update unit 50 updates the total use time from “00 hr. 00 min.” to “00 hr. 01 min.”. Then, the total use time update unit 50 outputs the updated total use time to the storage device 16 and outputs the updated total use time and the stocker number “#1” to the determination unit 52.

Now, it is assumed that the stocker number “#2” is output from the tool use detection unit 48 to the total use time update unit 50. In this case, the total use time update unit 50 adds the predetermined time to the total use time of “Zirconia-R0.5” stored on the storage device 16, namely, “00 hr. 15 min.”, to update the total use time. In the case where, for example, the predetermined time is “1 min.”, the total use time update unit 50 updates the total use time from “00 hr. 15 min.” to “00 hr. 16 min.”. Then, the total use time update unit 50 outputs the updated total use time to the storage device 16 and outputs the updated total use time and the stocker number “#2” to the determination unit 52.

The determination section 52 determines whether or not the total use time updated by the total use time update unit 50 has reached the time for replacement. The determination unit 52 first reads, from the storage device 16, the time for replacement of the target tool corresponding to the stocker number output from the total use time update unit 50. Then, the determination unit 52 compares the total use time output from the total use time update unit 50 (namely, the total use time updated by the total use time update unit 50) against the read time for replacement to determine whether the updated total use time has reached the time for replacement.

Specifically, when the updated total use time is shorter than the read time for replacement, the determination unit 52 determines that the updated total use time has not reached the time for replacement of the target tool. When the updated total use time is equal to, or exceeds, the read time for replacement, the determination unit 52 determines that the updated total use time has reached the time for replacement of the target tool.

Only when determining that the updated total use time has reached the time for replacement, the determination unit 52 outputs the determination result and the stocker number of the tool output from the total use time update unit 50 to the tool replacement instruction output unit 54.

When the determination result that the updated total use time has reached the time for replacement of the target tool is output from the determination unit 52, the tool replacement instruction output unit 54 reads the name information of the target tool from the storage device 16 and outputs, to the display device 18, an instruction to provide a display urging replacement of the target tool.

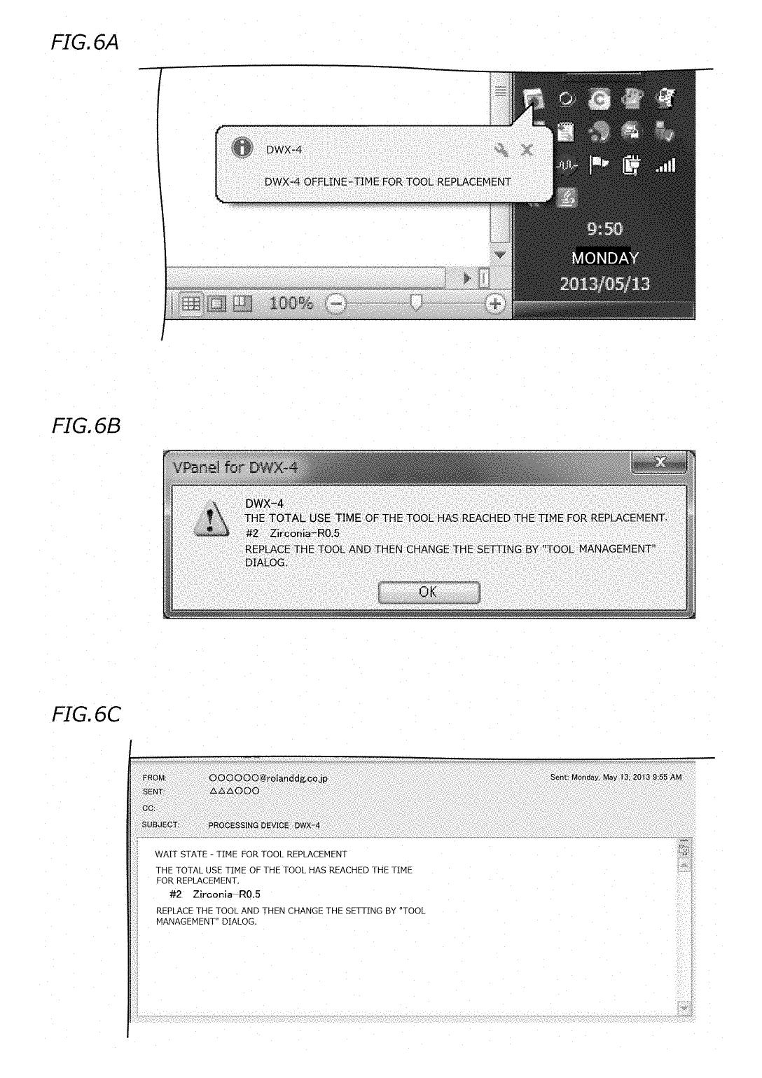

The tool replacement instruction output unit 54 is configured to monitor the control unit (not shown) in the processing device 100 and output different instructions before and after the processing operation. Specifically, when the processing device 100 is in the middle of performing the processing operation, the tool replacement instruction output unit 54 outputs, to the display device 18, an instruction to display a balloon message that is unlikely to obstruct various displays as a message urging replacement of the tool (see FIG. 6a). When the processing device 100 has finished the processing operation, the tool replacement instruction output unit 54 outputs, to the display device 18, an instruction to provide a dialog display as a message urging replacement of the tool (see FIG. 6b).

The tool replacement instruction output unit 54 optionally transmits a message urging replacement of the tool to a pre-input e-mail address of the operator (see FIG. 6c). Before the transmission, the tool replacement instruction output unit 54 determines whether or not a message urging replacement of the target tool, the total use time of which is determined as having reached the time for replacement, has been transmitted by e-mail during a tool life management process performed currently. When determining that the message has been transmitted by e-mail, the tool replacement instruction output unit 54 does not transmit the message by e-mail; whereas when determining that the message has not been transmitted by e-mail, the tool replacement instruction output unit 54 transmits the message by e-mail.

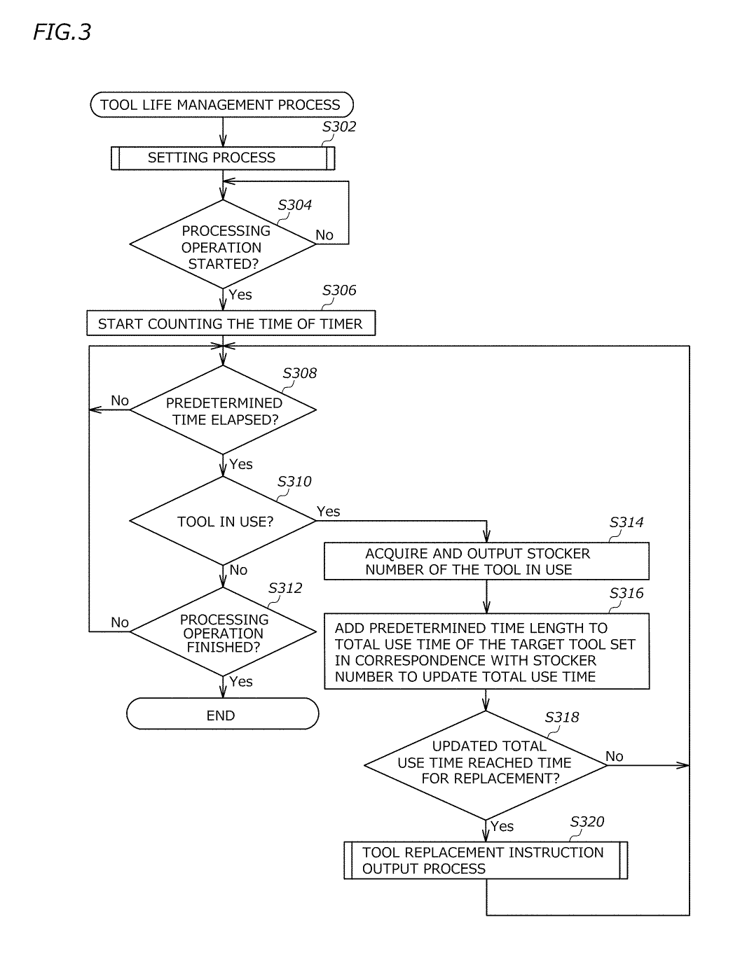

Now, with reference to the flowchart in FIG. 3, a non-limiting example of a tool life management process performed by the tool management system 10 will be described.

When the tool management system. 10 is started, a processing routine of the tool life management process is started, and a setting process of setting the tool information and a target tool, the life of which is to be managed, is performed (step S302).

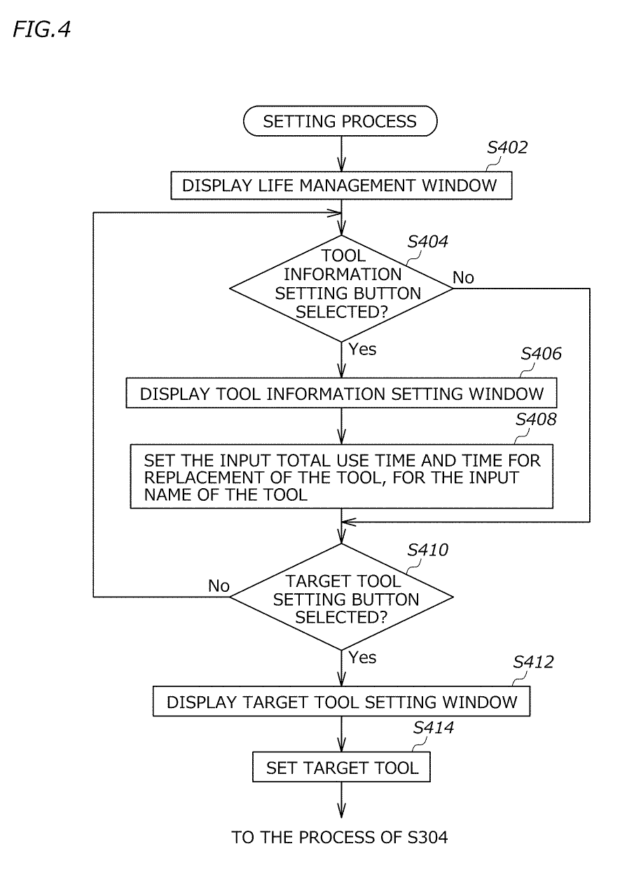

FIG. 4 is a flowchart showing the setting process of step S302 in detail. In the setting process, first, a life management window (not shown) is displayed on the display device 18 (step S402). The life management window includes a tool information setting button and a target tool setting button. The tool information setting button is used to set tool information such as, for example, the name information, the total use time, and the time for replacement of each of the tools accommodated in the stocker. The target tool setting button is used to set a target tool, the life of which is to be managed.

When the life management window (not shown) is displayed, it is first determined whether or not the tool information setting button has been selected (step S404).

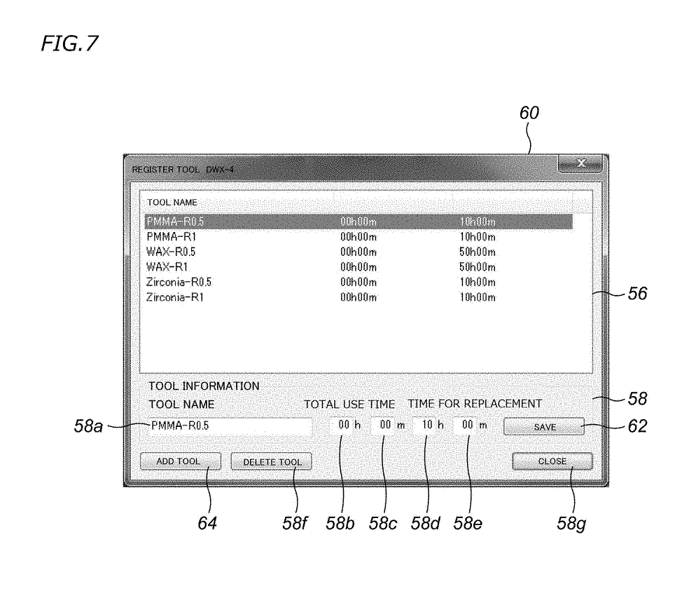

When, in the process of step S404, it is determined that the tool information setting button has been selected, a tool information setting window 60 (see FIG. 7) is displayed on the display device 18 (step S406). The tool information setting window 60 includes a tool information display area 56 that displays tool information already input (name information, total use time, and time for replacement) and a tool information input area 58 to which new tool information is to be input.

Then, when the operator inputs new tool information to the tool information setting window 60, the tool information setting unit 42 sets the input total use time and time for replacement for the input name information of the tool (step S408), and the process advances to step S410 described alter.

Specifically, in order to input new tool information, the operator preferably inputs name information of a tool to be newly input to a tool name input box 58a provided in the tool information input area 58. The operator also preferably inputs a total use time of the tool to “total use time” input boxes 58b and 58c, and inputs a time for replacement of the tool to “time for replacement” input boxes 58d and 58e. The “total use time” input box 58b and the “time for replacement” input box 58d accept input of numerical figures in units of hours, and the “total use time” input box 58c and the “time for replacement” input box 58e accept input of numerical figures in units of minutes.

A DELETE TOOL button 58f is used to delete tool information displayed in the tool information display area 56. A CLOSE button 58g is used to close the tool information setting window 60.

When the operator clicks a SAVE button 62 after inputting tool information, the input tool information is displayed in the tool information display area 56. When the operator clicks an ADD TOOL button 64, the tool information setting unit 42 sets the total use time and the time for replacement for the input name information of the tool and outputs the set tool information to the storage device 16.

When, in the process of step S404, it is determined that the tool information setting button has not been selected, it is determined whether or not the target tool setting button displayed on the life management window (not shown) has been selected (step S410).

When, in the determination process of step S410, it is determined that the target tool setting button has not been selected, the process returns to step S404. By contrast, when, in the process of step S410, it is determined that the target tool setting button has been selected, a target tool setting window 68 (see FIG. 8) is displayed on the display device 18 (step S412).

The target tool setting window 68 includes target tool name input pull-downs 68a each used to input a target tool name in correspondence with a stocker number in the processing device 100 and a REGISTER TOOL button 68b used to register the input name information of the target tool.

When the operator inputs information on a tool to the tool setting window 68, the tool setting unit 44 sets the input tool as a target tool, the life of which is to be managed (step S414), and the process advances to step S304 described later.

In the process of step S414, the operator selects, from the tool names displayed in a pull-down menu in each of the target tool name input pull-downs 68a, name information of a tool accommodated at each stocker number in the stocker. Then, when the operator clicks the REGISTER TOOL button 68b, the tool setting unit 44 sets the name of the tool selected by use of the target tool name input pull-down 68a as a target tool such that the tool name corresponds to the stocker number.

In the pull-down menu of each target tool name input pull-down 68a, tool names set by the tool information setting unit 42 are displayed. When a tool is selected from the pull-down menu, the total use time and the time for replacement corresponding to the selected tool name are displayed. The operator selects a tool name corresponding to the stocker number while checking such a display.

RESET buttons 68c are each used to make the total use time of the post-replacement tool “00 hr. 00 min.”, and is clicked when the tool, the total use time has reached the time for replacement, is replaced. A CLOSE button 68d is used to close the target tool setting window 68.

When the process of step S302 is finished, the count unit 46 determines whether or not the processing operation has been started by the processing device 100 (step S304). In more detail, when the target tool is set, the count unit 46 starts monitoring the control unit (not shown) in the processing device 100 and determines whether or not the processing operation has been started by the processing device 100.

When, in the process of step S304, determining that the processing operation has been started by the processing device 100, the count unit 46 starts counting the time measured by the timer 32 (step S306). By contrast, when, in the process of step S304, it is determined that the processing operation has not been started by the processing device 100, the process of step S304 is repeated.

When the processing operation is started by the processing device 100, the count unit 46 determines whether or not a predetermined time, for example, 1 minute, has elapsed (step S308). In the process of step S308, the count unit 46 determines whether or not the count number has reached a predetermined count number.

When, in the process of step S308, determining that the predetermined time, for example, 1 minute, has elapsed, the count unit 46 outputs, to the tool use detection unit 48, a signal indicating that the predetermined time, for example, 1 minute, has elapsed. The tool use detection unit 48 determines whether or not a tool is in use (step S310). When, in the process of step S308, it is determined that the predetermined time, for example, 1 minute, has not elapsed, the process of step S308 is repeated.

When, in the process of step S310, determining that no tool is in use, the tool use detection unit 46 determines whether or not the processing operation has been finished (step S312). When, in the process of step S312, it is determined that the processing operation has not been finished, the process returns to step S308. When it is determined that the processing operation has been finished, the tool life management process is terminated.

When, in the process of step S310, detecting that a tool is in use in the processing device 100, the tool use detection unit 48 acquires the stocker number of the tool in use and outputs the stocker number to the total use time update unit 50 (step S314).

Then, the total use time update unit 50 reads, from the storage device 16, the total use time of the target tool corresponding to the stocker number output from the tool use detection unit 48. The total use time update unit 50 adds the above-described predetermined time (namely, the time counted in the process of step S308; for example, 1 minute) to the read total use time of the target tool to update the total use time of the target tool (step S316).

In the process of step S316, when the total use time of the target tool is updated, the updated total use time and the stocker number output from the tool use detection unit 48 are output to the determination unit 52. The updated total use time is output to, and stored on, the storage device 16.

Next, the determination unit 52 reads, from the storage device 16, the time for replacement of the target tool corresponding to the stocker number output from the total use time update unit 50. The determination unit 52 compares the time for replacement of the target tool against the total use time updated by the total use time update unit 50. Namely, the determination unit 52 determines whether or not the updated total use time has reached the time for replacement of the target tool (step S318).

When, in the process of step S318, it is determined that the updated total use time has not reached the time for replacement of the target tool, the process returns to step S308. When, in the process of step S318, determining that the updated total use time has reached the time for replacement of the target tool, the determination unit 52 outputs the determination result and the stocker number output from the total use time update unit 50 to the tool replacement instruction output unit 54. Then, a tool replacement instruction output process is started (step S320).

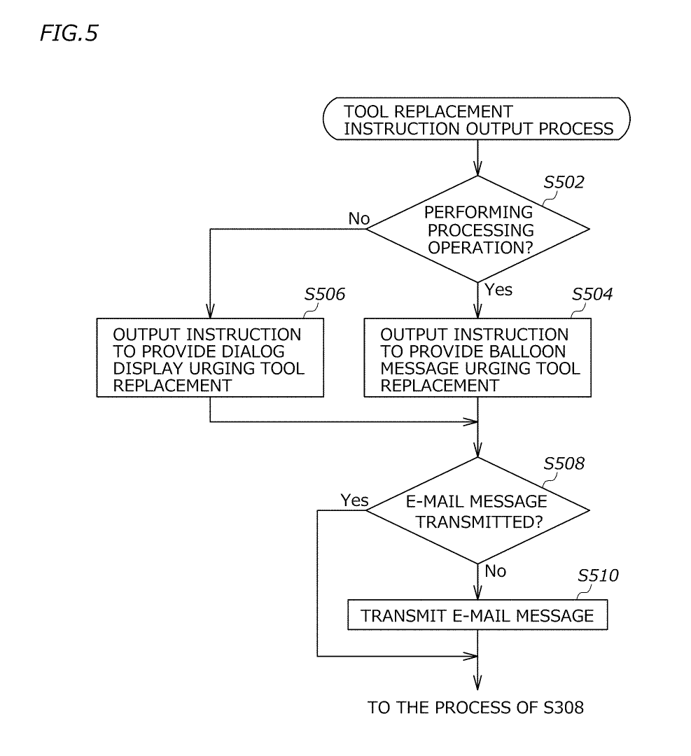

FIG. 5 is a flowchart showing the tool replacement instruction output process in detail. In the tool replacement instruction output process, first, when the determination result that the updated total use time has reached the time for replacement of the target tool is output from the determination unit 52, the tool replacement instruction output unit 54 monitors the control unit (not shown) in the processing device 100 and determines whether or not the processing operation is being performed (step S502). Namely, in the determination process of step S502, it is determined whether the processing device 100 is in the middle of performing the processing operation or has finished the processing operation.

When, in the process of step S502, determining that the processing operation is being performed, the tool replacement instruction output unit 54 outputs, to the display device 18, an instruction to provide a balloon message urging replacement of the target tool corresponding to the stocker number output from the determination unit 52 (step S504). The display device 18 provides a display based on the instruction (see FIG. 6a).

By contrast, when, in the process of step S502, determining that the processing operation is not being performed, namely, that the processing operation has been finished, the tool replacement instruction output unit 54 outputs, to the display device 18, an instruction to provide a dialog display urging replacement of the target tool corresponding to the stocker number output from the determination unit 52 (step S506). The display device 18 provides a display based on the instruction (see FIG. 6b).

After the process of step S504 or S506, it is determined whether or not a message urging replacement of the tool has been transmitted by e-mail during the tool life management process performed currently (S508). When, in the process of step S508, it is determined that the message has not been transmitted by e-mail, a message urging replacement of the target tool corresponding to the stocker number output from the determination unit 52 is transmitted to a pre-input e-mail address (step S510, see FIG. 6c). Then, the process returns to step S308.

By contrast, when, in the process of step S508, it is determined that the message has been transmitted by e-mail, the process returns to step S308 with no transmission of the message urging replacement of the target tool corresponding to the stocker number output from the determination unit 52.

Now, a second preferred embodiment of the tool management system will be described. Elements that are the same as, or corresponding to, those of the tool management system 10 in the first preferred embodiment will bear the same reference numerals thereto, and detailed descriptions thereof will be omitted.

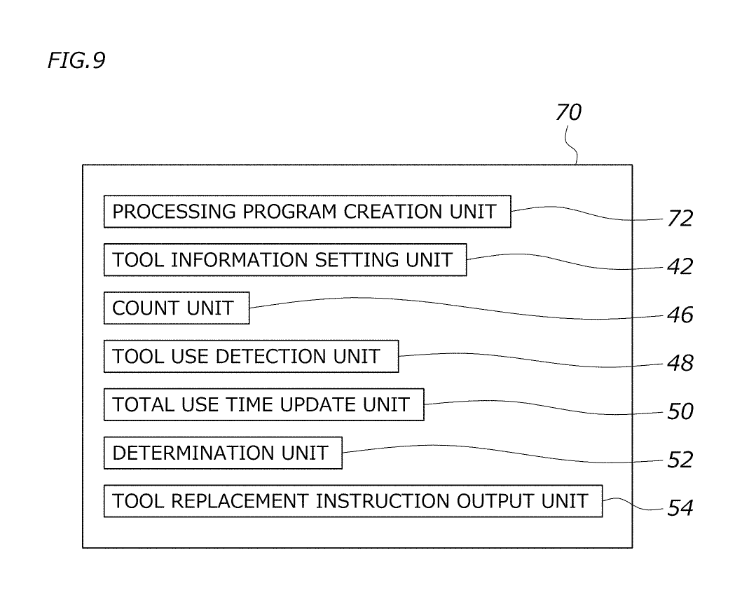

FIG. 9 is a block diagram showing a functional structure of a tool management system 70 in the second preferred embodiment. The hardware structure of the tool management system 70 in the second preferred embodiment prefer is substantially the same as that of the tool management system 10 in the first preferred embodiment, and the detailed description thereof will be omitted.

As described later, in the tool management system 70, a processing program creation unit 72 is configured to create a processing program based on processing data. Therefore, preferably no processing program is stored on the storage unit (not shown) in the processing device 100.

The tool management system 70 store is configured to names of tools to be used in the processing program, and when the total use time of a tool that is in use for the processing operation reaches the time for replacement of the tool, displays a message urging replacement of the tool. Unlike the tool management system 10 described above, the tool management system 70 preferably includes the processing program creation unit 72 instead of the tool setting unit 44.

The processing program creation unit 72 is configured to create a processing program based on processing data that indicates a shape of the work after the processing operation. When creating a processing program, the processing program creation unit 72 allows the processing program to include name information of tools to be used for the processing operation. While a tool is in use, the name information of the tool is continued to be read by the control unit (not shown) in the processing device 100. The process of creating the processing program based on the processing data may use a known technology, and will not be described in detail.

The tool information setting unit 42 and the count unit 46 preferably are substantially the same as those in the tool management system 10 described above, and will not be described in detail.

When the count unit 46 outputs a signal indicating that a predetermined time has elapsed, the tool use detection unit 48 monitors the control unit (not shown) in the processing device 100 and detects whether or not a tool is in use. When detecting that a tool is in use, the tool use detection unit 48 acquires name information of the tool in use. When a tool is in use, the name information of the tool in use has been read onto the control unit (not shown) in the processing device 100. There is no specific limitation on the method for detecting whether or not stool is in use. For example, when a spindle is rotated to perform a processing operation on a work in the processing device 100, it is determined that a tool is in use; and otherwise, it is determined that no tool is in use.

The tool use detection unit 48 outputs the name information of the tool in use to the total use time update unit 50. When detecting that no tool is in use, the tool use detection unit 48 monitors the control unit (not shown) in the processing device 100 and detects whether or not the processing operation has been finished in the processing device 100. Like in the tool management system 10 described above, there is no specific limitation on the method for detecting whether or not the processing operation has been finished.

The total use time update unit 50 adds the predetermined time to the total use time of the tool in use to update the total use time. The total use time update unit 50 first reads, from the storage device 16, the total use time of the tool corresponding to the name information of the tool in use that is output from the tool use detection unit 48. At this point, the tool information on the tools accommodated in the stocker provided in the processing device 100 has been preset by the operator and stored on the storage device 16. The total use time update unit 50 adds the predetermined time to the read total use time of the tool to update the total use time of the tool.

The total use time updated in this manner is output to, and stored on, the storage device 16. The total use time updated in this manner is also output to the determination unit 52 together with the name information of the tool in use.

It is assumed that, for example, the total use time and the time for replacement of a tool having name information “Zirconia-R1” are respectively “00 hr. 00 min.” and “10 hr. 00 min.”, and that the total use time and the time for replacement of a tool having name information “Zirconia-R0.5” are respectively “00 hr. 15 min.” and “10 hr. 00 min.”. Now, it is assumed that the name information “Zirconia-R1” is output from the tool use detection unit 48 to the total use time update unit 50. In this case, the total use time update unit 50 reads the total use time of the tool having the name information “Zirconia-R1” stored on the storage device 16, namely, “00 hr. 00 min.”, and adds the predetermined time to the total use time “00 hr. 00 min.” to update the total use time. In the case where, for example, the predetermined time is “1 min.”, the total use time update unit 50 updates the total use time from “00 hr. 00 min.” to “00 hr. 01 min.”. Then, the total use time update unit 50 outputs the updated total use time to the storage device 16 and outputs the updated total use time and the name information “Zirconia-R1” to the determination unit 52.

It is now assumed that name information “Zirconia-R0.5” is output from the tool use detection unit 48 to the total use time update unit 50. In this case, the total use time update unit 50 adds the predetermined time to the total use time of the tool having the name information “Zirconia-R0.5” stored on the storage device 16, namely, “00 hr. 15 min.”, to update the total use time. In the case where, for example, the predetermined time is “1 min.”, the total use time update unit 50 updates the total use time from “00 hr. 15 min.” to “00 hr. 16 min.”. Then, the total use time update unit 50 outputs the updated total use time to the storage device 16 and outputs the updated total use time and the name information “Zirconia-R1” to the determination unit 52.

The determination section 52 is configured to determine whether or not the total use time updated by the total use time update unit 50 has reached the time for replacement. The determination unit 52 first reads, from the storage device 16, the time for replacement of the tool corresponding to the name information of the tool in use that is output from the total use time update unit 50. Then, the determination unit 52 compares the updated total use time output from the total use time update unit 50 (namely, the total use time updated by the total use time update unit 50) against the read time for replacement of the tool to determine whether the updated total use time has reached the time for replacement.

Only when determining that the updated total use time has reached the time for replacement, the determination unit 52 outputs the determination result and the name information of the tool output from the total use time update unit 50 to the tool replacement instruction output unit 54.

When the determination result that the updated total use time has reached the time for replacement of the tool is output from the determination unit 52, the tool replacement instruction output unit 54 outputs, to the display device 18, an instruction to provide a display urging replacement of the tool by use of the name information of the tool that is output from the determination unit 52. The tool replacement instruction output unit 54 monitors the control unit (not shown) in the processing device 100 and outputs different instructions before and after the processing operation.

Specifically, when the processing device 100 is in the middle of performing the processing operation, the tool replacement instruction output unit 54 outputs, to the display device 18, an instruction to display a balloon message as a message urging replacement of the tool (see FIG. 6a). When the processing device 100 has finished the processing operation, the tool replacement instruction output unit 54 outputs, to the display device 18, an instruction to provide a dialog display as a message urging replacement of the tool (see FIG. 6b).

Like in the tool management system 10 described above, the tool replacement instruction output unit 54 transmits a message urging replacement of the tool to a pre-input e-mail address of the operator (see FIG. 6c).

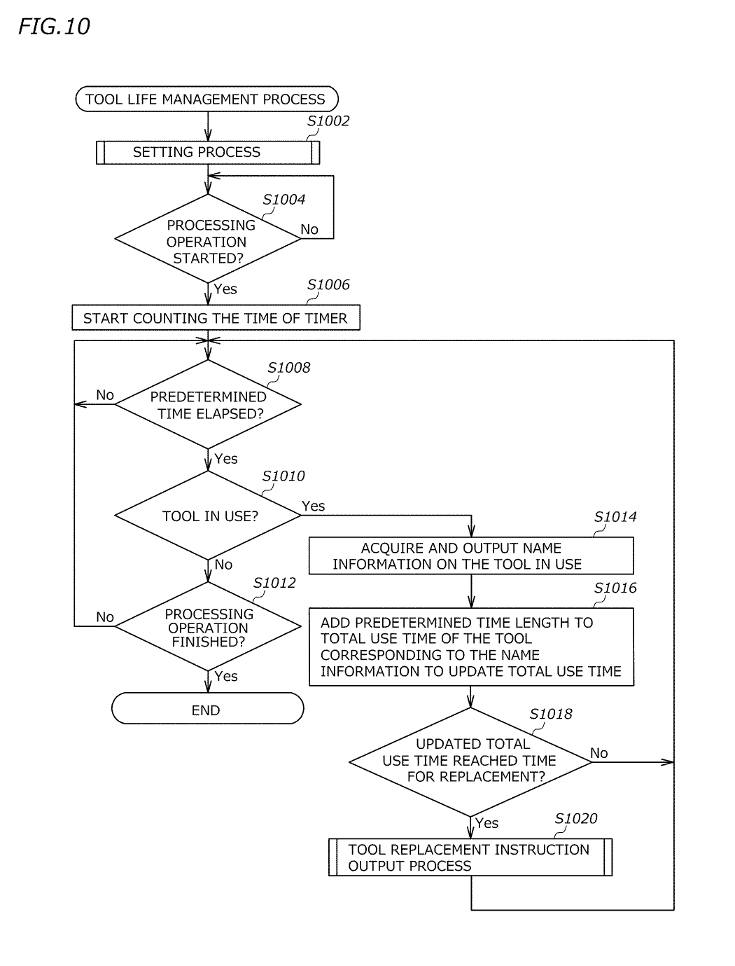

Now, with reference to the flowchart in FIG. 10, a tool life management process performed by the tool management system 70 will be described.

Before the tool life management process is performed by the tool management system 70, a processing program is created based on processing data that indicates a shape of the work after the processing operation. Namely, the processing program creation unit 72 creates a processing program from the processing data. In this process, a processing program including name information of tools is created such that a tool that is in use is continued to be read by the control unit (not shown) in the processing device 100.

After the processing program is created, the operator instructs start of the tool life management process. When the instruction is issued, a processing routine of the tool life management process is started, and a setting process of setting the tool information is performed (step S1002).

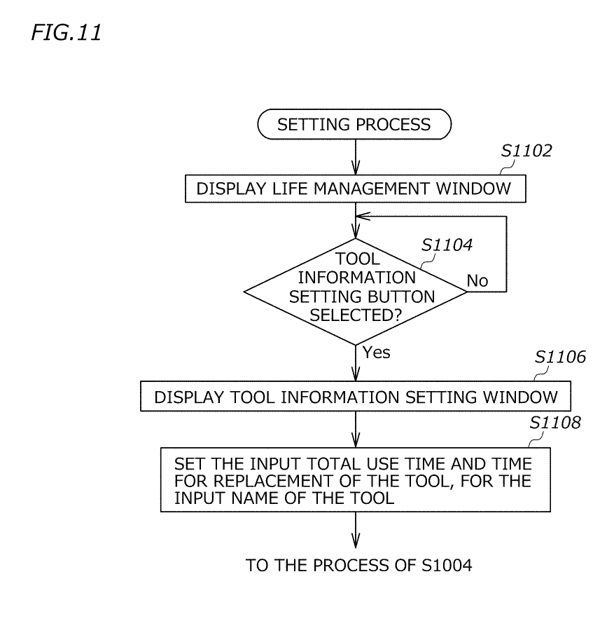

FIG. 11 is a flowchart showing the setting process of step S1002 in detail. In the setting process, first, a life management window (not shown) is displayed on the display device 18 (step S1102). The life management window includes a tool information setting button used to set tool information such as, for example, name information, a total use time, and a time for replacement of each of the tools accommodated in the stocker.

When the life management window (not shown) is displayed, it is first determined whether or not the tool information setting button has been selected (step S1104).

When, in the process of step S1104, it is determined that the tool information setting button has not been selected, the process of step S1104 is repeated. When, in the process of step S1104, it is determined that the tool information setting button has been selected, a tool information setting window 60 (see FIG. 7) is displayed on the display device 18 (step S1106). The tool information setting window 60 is as described above.

Then, the processes of steps S1106 and S1108 that preferably are substantially the same as those of steps S406 and S408 are performed.

When the process of step S1002 is finished, the count unit 46 determines whether or not the processing operation has been started by the processing device 100 (step S1004). In more detail, when the processing program including the name information of the tools is output to the processing device 100, the count unit 46 starts monitoring the control unit (not shown) in the processing device 100 and determines whether or not the processing operation has been started by the processing device 100.

When, in the process of step S1004, determining that the processing operation has been started by the processing device 100, the count unit 46 starts counting the time measured by the timer 32 (step S1006). By contrast, when, in the process of step S1004, it is determined that the processing operation has not been started by the processing device 100, the process of step S1004 is repeated.

When the processing operation is started by the processing device 100, the count unit 46 determines whether or not a predetermined time, for example, 1 minute, has elapsed (step S1008). In the process of step S1008, the count unit 46 determines whether or not the count number has reached a predetermined count number.

When, in the determination process of step S1008, determining that the predetermined time, for example, 1 minute, has elapsed, the count unit 46 outputs, to the tool use detection unit 48, a signal indicating that the predetermined time, for example, 1 minute, has elapsed. The tool use detection unit 48 determines whether or not a tool is in use for the processing operation (step S1010). When, in the process of step S1008, it is determined that the predetermined time, for example, 1 minute, has not elapsed, the process of step S1008 is repeated.

When, in the process of step S1010, determining that no tool is in use for the processing operation, the tool use detection unit 48 determines whether or not the processing operation has been finished (step S1012). When, in the process of step S1012, it is determined that the processing operation has not been finished, the process returns to step S1008. When it is determined that the processing operation has been finished, the tool life management process is terminated.

When, in the process of step S1010, detecting that a tool is in use in the processing device 100, the tool use detection unit 48 acquires the name information of the tool in use and outputs the name information to the total use time update unit 50 (step S1014).

Then, the total use time update unit 50 reads, from the storage device 16, the total use time of the tool corresponding to the name information output from the tool use detection unit 48. The total use time update unit 50 adds the above-described predetermined time (namely, the time counted in the process of step S1008; for example, 1 minute) to the read total use time of the tool to update the total use time of the tool (step S1016).

In the process of step S1016, when the total use time of the tool is updated, the updated total use time and the name information output from the tool use detection unit 48 are output to the determination unit 52. The updated total use time is output to, and stored on, the storage device 16.

Next, the determination unit 52 reads, from the storage device 16, the time for replacement of the tool corresponding to the name information output from the total use time update unit 50. The determination unit 52 compares the time for replacement of the tool against the total use time updated by the total use time update unit 50. Namely, the determination unit 52 determines whether or not the updated total use time has reached the time for replacement of the tool (step S1018).

When, in the process of step S1018, it is determined that the updated total use time has not reached the time for replacement of the tool, the process returns to step S1008. When, in the determination process of step S1018, determining that the updated total use time has reached the time for replacement of the tool, the determination unit 52 outputs the determination result and the name information output from the total use time update unit 50 to the tool replacement instruction output unit 54. Then, a tool replacement instruction output process is started (step S1020).

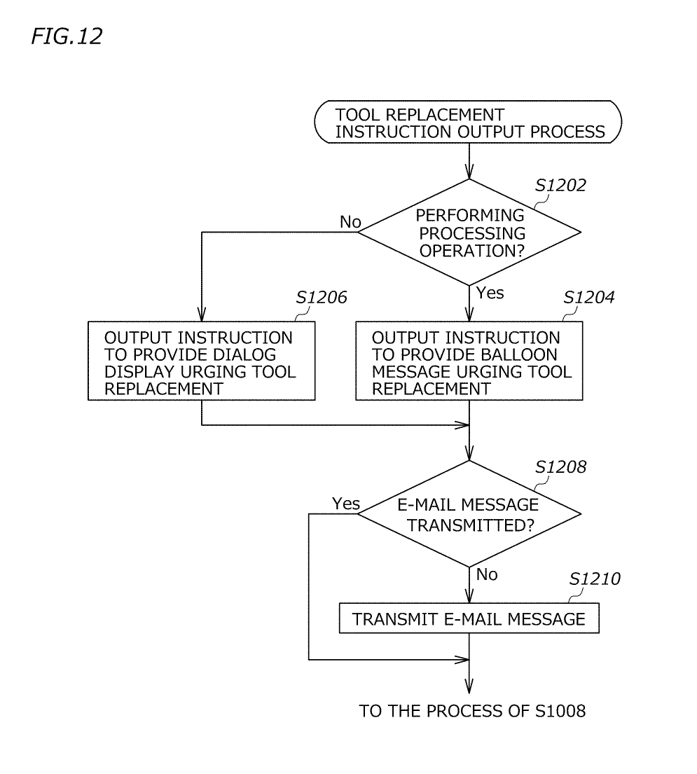

FIG. 12 is a flowchart showing the tool replacement instruction output process in detail. In the tool replacement instruction output process, first, when the determination result that the updated total use time has reached the time for replacement of the tool is output, the tool replacement instruction output unit 54 monitors the control unit (not shown) in the processing device 100 and determines whether or not the processing operation is being performed (step S1202). Namely, in the determination process of step S1202, it is determined whether the processing device 100 is in the middle of performing the processing operation or has finished the processing operation.

When, in the process of step S1202, it is determined that the processing operation is being performed, the tool replacement instruction output unit 54 output, to the display device 18, an instruction to provide a balloon message urging replacement of the tool by use of the name information output from the determination unit 52 (step S1204). The display device 18 provides a display based on the instruction (see FIG. 6a).

By contrast, when, in the process of step S1202, it is determined that the processing operation is not being performed, namely, that the processing operation has been finished, the tool replacement instruction output unit 54 outputs, to the display device 18, an instruction to provide a dialog display urging replacement of the tool by use of the name information output from the determination unit 52 (step S1206). The display device 18 provides a display based on the instruction (see FIG. 6b). In the case where the processing program creation unit 72 creates the processing program such that the stocker numbers (included in the processing program) respectively correspond to the name information of the tools, the stocker number and the name information preferably are displayed in the message urging replacement of the tool as shown in FIG. 6b.

After the process of step S1204 or S1206, it is determined whether or not a message urging replacement of the tool has been transmitted by e-mail during the tool life management process performed currently (S1208). In this process, a message urging replacement of the tool by use of the name information output from the determination unit 52 is transmitted.

When, in the determination process of step S1208, it is determined that the message has not been transmitted by e-mail, the message urging replacement of the tool by use of the name information output from the determination unit 52 is transmitted to a pre-input e-mail address (step S1210, see FIG. 6c). Then, the process returns to step S1008. In the case where the processing program creation unit 72 creates the processing program such that the stocker numbers (included in the processing program) respectively correspond to the name information of the tools, the stocker number and the name information preferably are displayed in the message urging replacement of the tool as shown in FIG. 6c.

By contrast, when, in the determination process of step S1208, it is determined that the message has been transmitted by e-mail, the process returns to step S1008 with no transmission of the message urging replacement of the tool by use of the name information output from the determination unit 52.

As described above, with the tool management system 10, the name information of tools to be used for the processing operation are set in correspondence with stocker numbers included in the processing program. The tool management system 10 acquires the stocker numbers so that when a tool is in use, the name information of the tool preferably is acquired. Even when the name information of the tool is not included in the processing program, the tool management system 10 acquires the name information of the tool while the tool is in use. When the total use time of the tool, the name information of which has been acquired, reaches the time for replacement, the tool management system 10 provides the operator with a display urging replacement of the tool that explicitly shows the name information of the tool.

With the tool management system 70, a processing program is created based on processing data, and the name information of tools to be used for the processing operation is included in the processing program. The tool management system 70 acquires the name information of the tool while the tool is in use. When the total use time of the tool, the name information of which has been acquired, reaches the time for replacement, the tool management system 70 provides the operator with a display urging replacement of the tool that explicitly shows the name information of the tool.

With the tool management systems 10 and 70, after various settings are made, the tool which has reached the end of the life is accurately and reliably detected with no need of management by the operator. In addition, a message urging replacement of the tool preferably is displayed while the name information of the detected tool is explicitly shown to the operator. Therefore, the tool management systems 10 and 70 do not require the operator to manage the total use time of the tools and accurately and reliably determines whether or not the tool has reached the end of the life.

The above-described preferred embodiments are merely illustrative and may be modified as follows, for example.

In the above-described preferred embodiments, the message urging replacement of the tool preferably is transmitted by e-mail in the tool replacement instruction output process. Alternatively, such a e-mail message may not be transmitted.

In the above-described preferred embodiments, the total use time of the tool preferably is input by the tool information setting unit 42. The present invention is not limited to this, needless to say.

For example, the tool information setting window 60 may be configured not to accept input of the total use time of the tool, and may be configured such that when the operator inputs the name information and the time for replacement of the tool, the time for replacement and “00 hr. 00 min.” as the total use time are set for the input name information of the tool.

In the above-described preferred embodiments, the display urging replacement of the tool preferably explicitly shows the name information of the tool, but the present invention is not limited to this, needless to say. The display urging replacement of the tool may not explicitly show the name information of the tool and may explicitly show information that allows the operator to grasp the tool to be replaced (e.g., stocker number).

In the above-described preferred embodiments, as shown in FIG. 6a, the balloon message urging replacement of the tool preferably does not show the name information of the tool, but the present invention is not limited to this, needless to say. The balloon message urging replacement of the tool may show the name information of the tool.

In the above-described preferred embodiment, the processing program creation unit 72 in the tool management system 70 preferably creates and outputs a processing program including name information of tools to be used for the processing operation, but the present invention is not limited to this.

The tool management system 70 may include, instead of the processing program creation unit 72, a processing program creation unit that is configured to create a processing program including the name information of tools, and when the operator make a setting such that the name information of the tools is included in the processing program, output the processing program to the processing device 100 (in the following description, the processing program creation unit provided instead of the processing program creation unit 72 will be referred to as the “processing program creation unit 72′”).

The processing program created by the processing program creation unit 72′ allows the operator to select and set whether or not the name information of the tools is included therein. When the operator makes a setting such that the name information of the tools is included, the processing program creation unit 72′ outputs a processing program including the name information of the tools. By contrast, when the operator makes a setting such that the name information of the tools is not included, the processing program creation unit 72′ outputs a processing program not including the name information of the tools.

In the case where the processing program creation unit 72′ is provided in the tool management system 70, the setting process corresponding to the process of step S1002 in the tool life management process includes a setting on whether or not the name information of the tools is to be included in the processing program to be output to the processing device 100 in addition to the setting of the tool information.

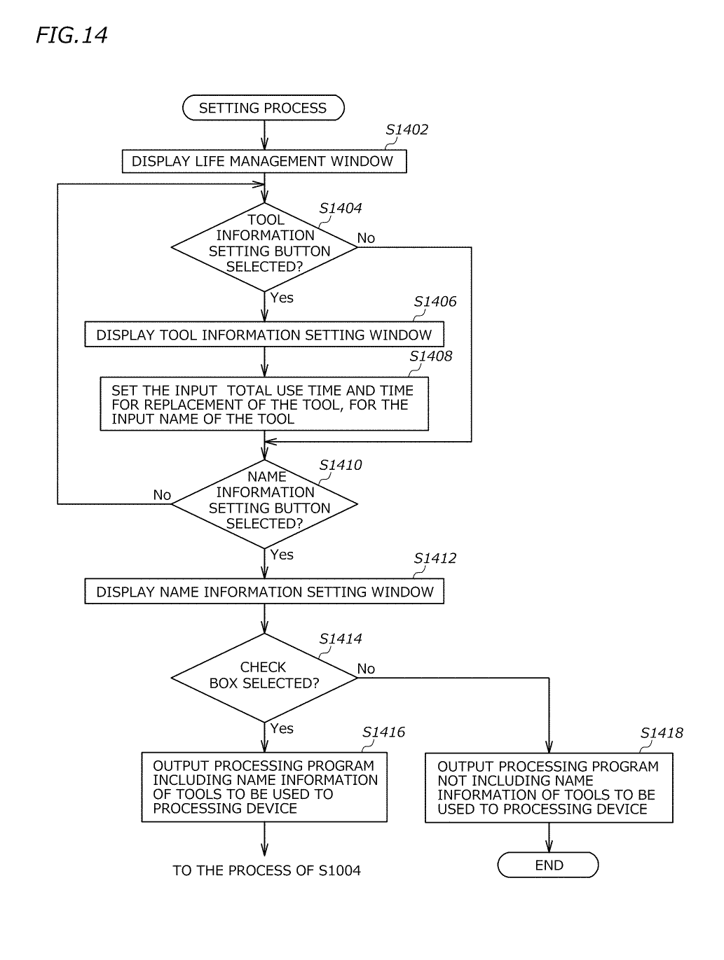

FIG. 14 is a flowchart showing such a setting process in detail. In the setting process, when the tool life management process is started, first, a life management window (not shown) is displayed on the display device 18 (step S1402). The life management window includes the tool information setting button described above and a name information setting button. The name information setting button is used to make a setting such that the name information of tools is included in the processing program.

When the life management window (not shown) is displayed, it is first determined whether or not the tool information setting button has been selected (step S1404).

In steps S1404, S1406 and S1408, processes that preferably are substantially the same as those of steps S404, S406 and S408 are performed.

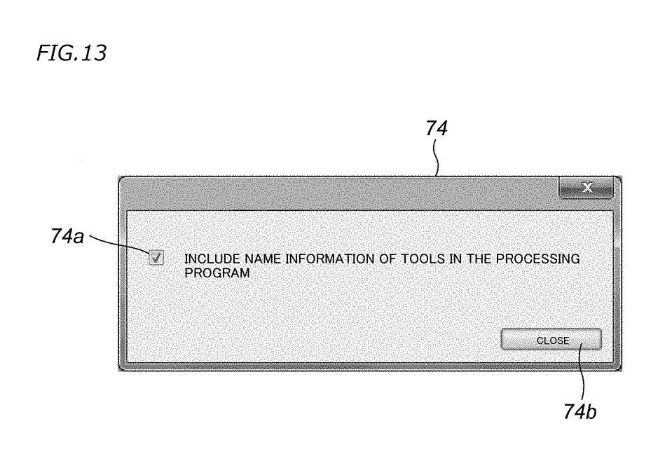

When, in the process of step S1404, it is determined that the tool information setting button has not been selected, it is determined whether or not the name information setting button displayed on the life management window (not shown) has been selected (step S1410). When, in the process of step S1410, it is determined that the name information setting button has not been selected, the process returns to step S1404. By contrast, when, in the determination process of step S1410, it is determined that the name information setting button has been selected, a name information setting window 74 (see FIG. 13) is displayed on the display device 18 (step S1412).

The name information setting window 74 includes a check box 74a used to make a setting that “the name information of tools is included in the processing program”. A CLOSE button 74b is used to close the name information setting window 74.

Then, it is determined whether or not the operator has checked the check box 74a in the name information setting window 74 (step S1414). In the process of step S1414, it is determined whether the check box 74a has been selected, or the check box 74a has not been selected but the CLOSE button 74b has been selected.

When, in the determination process of step S1414, it is determined that the check box 74a has not been selected (namely, it is determined that the check box 74a has not been selected but the CLOSE button 74b has been selected), the processing program creation unit 72′ outputs a processing program not including the name information of the tools (step S1418). Then, the tool life management process is terminated.

By contrast, when, in the determination process of step S1414, it is determined that the check box 74a has been selected, the processing program creation unit 72′ outputs a processing program including the name information of the tools to be used (step S1416). Then, the process advances to step S1004. This will be described in more detail. When the operator has selected the check box 74a, a check mark is displayed in the check box 74a. In addition, the processing program including the name information of the tools is output to the processing device 100 so that while the processing operation is performed by use of a tool, the name information of the tool that is in use for the processing operation is continued to be read by the control unit (not shown) in the processing device 100.

As shown in FIG. 13, the name information setting window 74 includes the check box 74a used to make a setting that “the name information of the tools is included in the processing program”. In addition, the name information setting window 74 may include a check box used to make a setting that “the name information of the tools is not included in the processing program”. In this case, the operator can select either one of the check boxes to select and make a setting on whether or not the name information of the tools is included in the processing program.

In the above-described preferred embodiments, when the process routine of the tool life management process is started, the life management window including the tool information setting button used to set the tool information is displayed. When the tool information setting button is selected, the tool information setting window 60 is displayed. The present invention is not limited to these processes however. The tool information setting window 60 may be displayed immediately when the process routine of the tool life management process is started.

The above-described preferred embodiments and modifications may be optionally combined.

The terms and expressions used herein are used for explanation purposes and should not be construed as being restrictive. It should be appreciated that the terms and expressions used herein do not eliminate any equivalents of features illustrated and mentioned herein, but allow various modifications falling within the claimed scope of the present invention. The present invention may be embodied in many different forms. The present disclosure is to be considered as providing examples of the principles of the present invention. These examples are described herein with the understanding that such examples are not intended to limit the present invention to preferred embodiments described herein and/or illustrated herein. Hence, the present invention is not limited to the preferred embodiments described herein. The present invention includes any and all preferred embodiments including equivalent elements, modifications, omissions, combinations, adaptations and/or alterations as would be appreciated by those skilled in the art on the basis of the present disclosure. The claims are to be interpreted broadly based on the language used in the claims and not limited to examples described in the present specification or during the prosecution of the application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A tool management system comprising:
a display device;
a processing device that performs a processing operation by executing a processing program and includes a stocker including a plurality of positions at which a plurality of tools are accommodated, each of the plurality of tools being assigned a stocker number; and
a processor that is programmed to implement:
a first setting unit that sets name information, a total use time and a time for replacement for each of the plurality of tools based on an input by an operator;
a second setting unit that sets whether or not the name information of the plurality of tools is included in the processing program based on the input by the operator;
a storage unit that stores the name information, the total use time and the time for replacement of each of the plurality of tools set by the first setting unit;
a creation unit that creates and outputs to the processing device a first processing program that includes the name information of the plurality of tools when the name information of the plurality of tools is set to be included by the second setting unit and a second processing program that does not include the name information of the plurality of tools when the name information of the plurality of tools is not set to be included by the second setting unit;
a detection unit that detects whether or not one of target tools of the plurality of tools is in use at an interval of a predetermined time in the processing operation when the first processing program is output to the processing device;
an acquisition unit that, when the detection unit detects that one of the target tools is in use, acquires the name information of the target tool in use from the first processing program;
an update unit that acquires the total use time of the target tool corresponding to the name information acquired by the acquisition unit and adds the predetermined time to the acquired total use time to update the total use time;
a determination unit that acquires the time for replacement of the target tool corresponding to the name information acquired by the acquisition unit and determines whether or not the total use time updated by the update unit has reached the time for replacement; and
an output unit that, when the determination unit determines that the total use time updated by the update unit has reached the time for replacement, outputs an instruction to provide a display on the display device urging replacement of the target tool.

2. A tool management system according to claim 1, wherein the output unit outputs an instruction to provide a display on the display device explicitly showing the name information of the target tool.

3. A tool management system according to claim 1, wherein
when the processing device is performing the processing operation, the output unit outputs an instruction to provide a balloon message on the display device urging replacement of the target tool; and
when the processing device has finished the processing operation, the output unit outputs an instruction to provide a dialog display on the display device urging replacement of the target tool.

4. A tool management system according to claim 1, wherein the output unit transmits, by e-mail, a message urging replacement of the target tool to a pre-input e-mail address.

5. A tool management method comprising:
storing, in a stocker of a processing device, a plurality of tools accommodated at a plurality of positions; and
controlling the processing device by:
a first setting step of setting name information, a total use time and a time for replacement for each of a plurality of tools based on an input by an operator;
a second setting step of setting whether or not the name information of the plurality of tools is included in a processing program based on the input by the operator;
a creation step of creating and outputting to the processing device a first processing program that includes the name information of the plurality of tools when the name information of the plurality of tools is set to be included by the second setting unit and a second processing program that does not include the name information of the plurality of tools when the name information of the plurality of tools is not set to be included by the second setting unit;
a detection step of detecting whether or not one of target tools of the plurality of target tools is in use at an interval of a predetermined time in a processing operation when the first processing program is output to the processing device;
an acquisition step of, when it is detected that one of the target tools is in use, acquiring the name information of the target tool in use from the first processing program;
an update step of acquiring the total use time of the target tool corresponding to the name information acquired in the acquisition step and adding the predetermined time to the acquired total use time to update the total use time;
a determination step of acquiring the time for replacement of the target tool corresponding to the name information acquired in the acquisition step and determining whether or not the total use time updated in the update step has reached the time for replacement; and
an output step of, when it is determined in the determination step that the total use time has reached the time for replacement, outputting an instruction to provide a display, on a display device, urging replacement of the target tool.

6. A tool management method according to claim 5, wherein the output step includes outputting an instruction to provide a display on the display device explicitly showing the name information of the target tool.

7. A tool management method according to claim 5, wherein
the output step includes outputting an instruction to provide a balloon message on the display device urging replacement of the target tool when the processing device is performing the processing operation; and
the output step includes outputting an instruction to provide a dialog display on the display device urging replacement of the target tool when the processing device has finished the processing operation.

8. A tool management method according to claim 5, wherein the output step includes transmitting, by e-mail to a pre-input e-mail address, a message urging replacement of the target tool.

9. A non-transitory computer-readable storage medium storing a computer program that allows a computer to perform a tool management method comprising:
storing, in a stocker of a processing device, a plurality of tools accommodated at a plurality of positions; and
controlling the processing device by performing:
a first setting step of setting name information, a total use time and a time for replacement for each of a plurality of tools based on an input by an operator;
a second setting step of setting whether or not the name information of the plurality of tools is included in the processing program based on the input by the operator;
a creation step of creating and outputting to the processing device a first processing program that includes the name information of the plurality of tools when the name information of the plurality of tools is set to be included by the second setting unit and a second processing program that does not include the name information of the plurality of tools when the name information of the plurality of tools is not set to be included by the second setting unit;
a detection step of detecting whether or not one of target tools of the plurality of target tools is in use at an interval of a predetermined time in a processing operation when the first processing program is output to the processing device;
an acquisition step of, when it is detected that one of the target tools is in use, acquiring the name information of the target tool in use from the first processing program;
an update step of acquiring the total use time of the target tool corresponding to the name information acquired in the acquisition step and adding the predetermined time to the acquired total use time to update the total use time;
a determination step of acquiring the time for replacement of the target tool corresponding to the name information acquired in the acquisition step and determining whether or not the total use time updated in the update step has reached the time for replacement; and
an output step of, when it is determined in the determination step that the total use time has reached the time for replacement, outputting an instruction to provide a display, on a display device, urging replacement of the target tool.
